(19) United States
(12) Patent Application Publication
(10) Pub. No.: US 2009/0005085 A1
(43) Pub. Date: Jan. 1, 2009

(54) SELECTIVE RETRY SYSTEM FOR A CODE DIVISION MULTIPLE ACCESS STACK FOR CALL SETUP FAILURES

(75) Inventor: SABARISH NARAYANA DAS, Des Plaines, IL (US)

Correspondence Address: BRINKS HOFER GILSON & LIONE, P.O. BOX 10395, CHICAGO, IL, 60610, US

(73) Assignee: Motorola, Inc., Schaumburg, IL (US)

(21) Appl. No.: 12/142,556

(22) Filed: Jun. 19, 2008

Related U.S. Application Data
(60) Provisional application No. 60/946,869, filed on Jun. 28, 2007.

(51) Int. Cl. H04Q 7/00; H04B 7/216

(52) U.S. Cl. 455/460; 370/335

(57) ABSTRACT

A code division multiple access stack in a mobile station (205) re-attempts a call connection using a selective retry process, without notifying a mobile station user, when the mobile station (205) receives messages related to error conditions from a network (215), before the mobile station (205) receives a call alerting message from the network (215).

### BACKGROUND

The present disclosure relates to wireless code division multiple access (WCDMA) networks. In particular, it relates to call setup retry processes for a WCDMA stack.

For call setup failures, the current retry mechanisms may include a “CALL FAILED—RETRY” option provided to the user. FIG. 1 illustrates a conventional call retry process according to the prior art. The caller is notified, at step 102, that the call failed. A “RETRY” soft key is provided, at step 104, prompting the user to attempt the call again. An “AUTO REDIAL” option may also be provided, at step 106. The phone re-attempts the call, at step 108. In both cases, the caller is notified that the call setup failed, leading to poor user perception of the phone service. This is a big concern when call setup failure are due to network issues, such as congestion, network failure, or other errors.

### BRIEF DESCRIPTION OF THE DRAWINGS

Embodiments of the present disclosure are now described, by way of example only, with reference to the accompanying figures in which:

FIG. 1 illustrates a conventional call retry process according to the prior art.

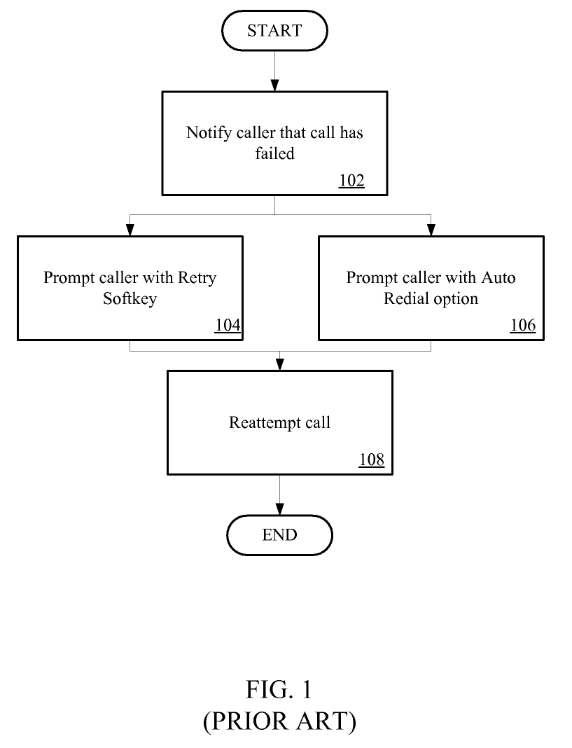

FIG. 2 illustrates an example 3G network.

FIG. 3 is a schematic block diagram of a 3G device.

FIG. 4 illustrates an example process for a selective call retry.

### DETAILED DESCRIPTION

The present disclosure is defined by the appended claims. This description summarizes some aspects of the present embodiments and should not be used to limit the claims. While the present disclosure may be embodied in various forms, there are shown in the drawings and will hereinafter be described some exemplary and non-limiting embodiments, with the understanding that the present disclosure is to be considered an exemplification of the disclosure and is not intended to limit the present disclosure to the specific embodiments illustrated.

In this application, the use of the disjunctive is intended to include the conjunctive. The use of definite or indefinite articles is not intended to indicate cardinality. In particular, a reference to “the” object or “a and an” object is intended to denote also one of a possible plurality of such objects.

In a preferred embodiment, a selective retry system attempts to re-establish a call connection, without notifying the user, under certain conditions. The selective retry system retries the call only when a mobile station or “mobile originating” (MO) side has not received a call control (CC) Alerting message. The CC Alerting message is an indication that the mobile terminating (MT) side, such as a WCDMA network, has received the call.

In one embodiment, the selective retry system re-attempts a call when a call setup failure is due to a radio resource control (RRC) Connection release, which is received before receiving the CC Alerting message on the MO side. The RRC Connection release indicates that the network has requested the mobile station to release. In another embodiment, the selective retry system re-attempts a call when a call setup failure is due to a CC Disconnect message due to certain error messages which are received before receiving the CC Alerting message on the MO side. In another embodiment, the selective retry system re-attempts a call when a call setup failure is due to a CC Release message due to certain error messages which are received before receiving the CC Alerting message on the MO side.

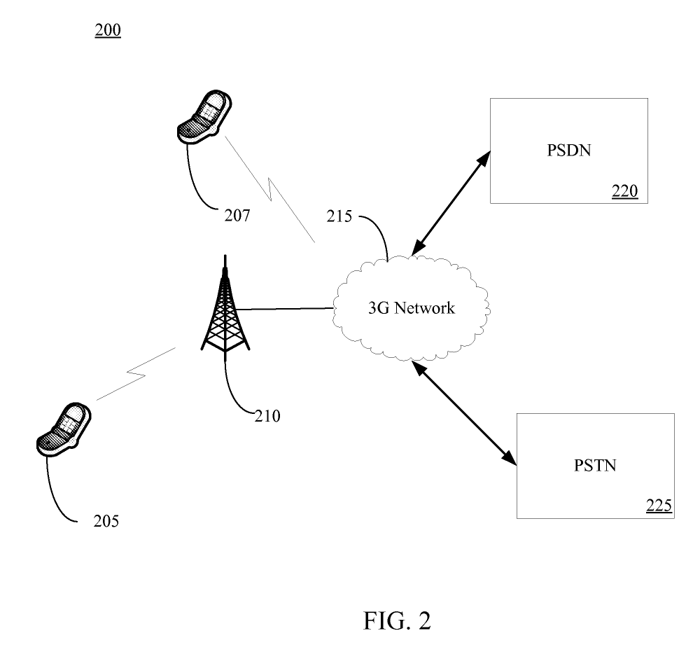

FIG. 2 illustrates an example schematic block diagram of a wireless communications network 200, such as a third generation (3G) W-CDMA network. The wireless communications network includes a wireless user equipment (UE) 205, a transceiver base station, such as a Node B 210, a 3G network 215, a Public Switched Data Network (PSDN) 220, and a Public Switched Telephone Network (PSTN) 225.

The wireless UE 205 may be a cellular telephone configured to operate with the W-CDMA protocol. The wireless UE 205 may include other devices that transmit and receive data signals interoperable with the W-CDMA protocol. The Node-B 210 is a term used in UMTS (Universal Mobile Telecommunications System) to denote the base transceiver station (BTS) in a 3G network. The Node B 210 contains radio frequency transmitters and receivers used to communicate directly with the wireless UE's 205. In this type of cellular network, the wireless UE's cannot communicate directly with each other but have to communicate with the Nodes B 210.

The 3G network 215 includes components that connect the wireless UE 205 and the Node B 210 with other components, such as the PSDN 220 and the PSTN 225. The 3G network 215 includes support nodes, servers, and gateways operable to transmit the data carried within the 3G network 215 and between the wireless UE 205 and the PSDN 220 and/or the PSTN 225.

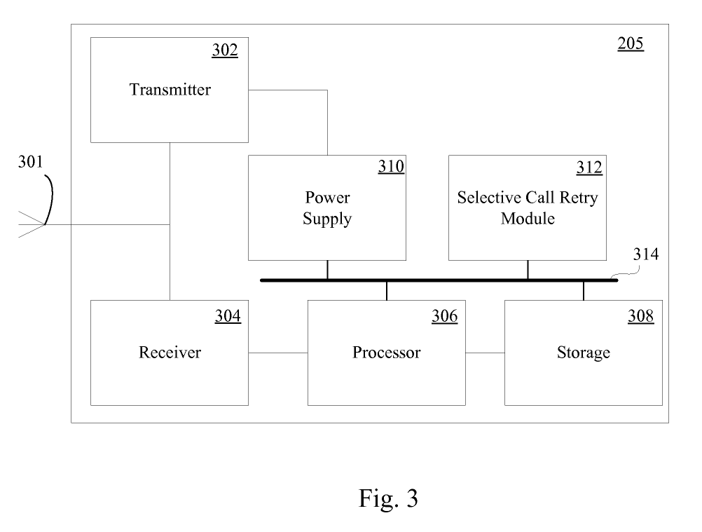

FIG. 3 illustrates a schematic block diagram of an example UE 205. The UE 205 includes an antenna 301, a transmitter 302, a receiver 304, a processor 306, a storage 308, a power supply 310, and a selective call retry module 312. In an exemplary embodiment, the antenna 301 may be coupled to both the transmitter 302 and the receiver 304, or the transmitter 302 and the receiver 304 may be connected to respective antenna units. In another exemplary embodiment, the processor 306, the storage 308, the power supply module 310, and the selective call retry module 312 are coupled to each other through a communications bus 314. The communications bus 314 is operable to transmit control and communications signals from and between the components connected to the bus 314, such as power regulation, memory access instructions, and other system information. The processor 306 is coupled to the receiver 304, and the transmitter 302 is coupled to the receiver 304 and to the processor 306.

The UE 205 is configured to connect with the 3G network 215 to initiate a call. A call stack in the UE 205 may initiate a call attempt based on specifications in the 3rd Generation Partnership Project (3GPP) standard. For example, the call stack of the mobile station may initiate establishment of a CC connection by requesting a mobility management (MM) sublayer to establish a mobile originating MM connection and entering a “MM connection pending” state. The network 215 may transmit messages to the UE 205 indicating a status of the call connection. The network 215 may transmit RRC Connection release messages, CC Disconnect messages, and/or CC Release messages to the UE 205, based on the 3GPP specification.

In a one embodiment, the selective retry module 312 re-attempts a call when a call setup failure is due to a call connection message, such as a radio resource control (RRC) Connection release message, before receiving the CC Alerting message on the MO side (i.e., the UE 205). The CC Alerting message indicates that user alerting has been initiated at the called address, such as another UE 207. Initiation of user alerting may include the generation of an appropriate tone or indication at the called mobile station, and sending of an ALERTING message by the call control entity of the UE 205 to its peer entity in the network 215 and entering the “call received” state. The RRC Connection release message is configured to cause the UE 205 to release the call.

In another embodiment, the selective retry module 312 re-attempts a call when a call setup failure is due to a call connection message, such as a CC Disconnect due to certain error messages that are received by the UE 205 before receiving the CC Alerting message. Examples of the received error messages include, but are not limited to, “pre-emption,” “no circuit/channel available,” “network out of order,” “temporary failure,” “switching equipment congestion,” “requested service/channel not available,” “resource unavailable, unspecified,” “invalid transaction identifier value,” “invalid transit network selection,” “semantically incorrect message,” “invalid mandatory information,” “message type non-existent or not implemented,” “message type not compatible with protocol state,” “information element non existent or not implemented,” “conditional IE error,” “message not compatible with protocol state,” “recovery on timer expiry,” “protocol error, unspecified,” and “interworking, unspecified” error messages.

In yet another embodiment, the selective retry module 312 re-attempts a call when a call setup failure is due to a call connection message, such as a CC Release due to certain error messages which are received by the UE 205 before receiving the CC Alerting message. Examples of the received error messages include, but are not limited to, “pre-emption,” “no circuit/channel available,” “network out of order,” “temporary failure,” “switching equipment congestion,” “requested service/channel not available,” “resource unavailable, unspecified,” “invalid transaction identifier value,” “invalid transit network selection,” “semantically incorrect message,” “invalid mandatory information,” “message type non-existent or not implemented,” “message type not compatible with protocol state,” “information element non-existent or not implemented,” “conditional IE error,” “message not compatible with protocol state,” “recovery on timer expiry,” “protocol error, unspecified,” and “interworking, unspecified” error messages.

In the various embodiments, only one call retry may be attempted. The selective retry module 312 may be configured to attempt a call retry based on failures due to RL (radio link) Failure and RLC (radio link control) Unrecoverable Error.

The power supply 310 provides power to the components for the UE 305. The power supply 310 may include power conditioning and power filtering components operable to ensure a smooth power signal to the transmitter 302. The storage 308 stores data required for operation of the UE 205, channel initialization parameters, and other data used by the processor 306 for operation. The storage 308 may store other data, such as data packets to be transmitted by the UE 205, data packets received by the receiver 204, or buffered data that is retrieved by the processor 206.

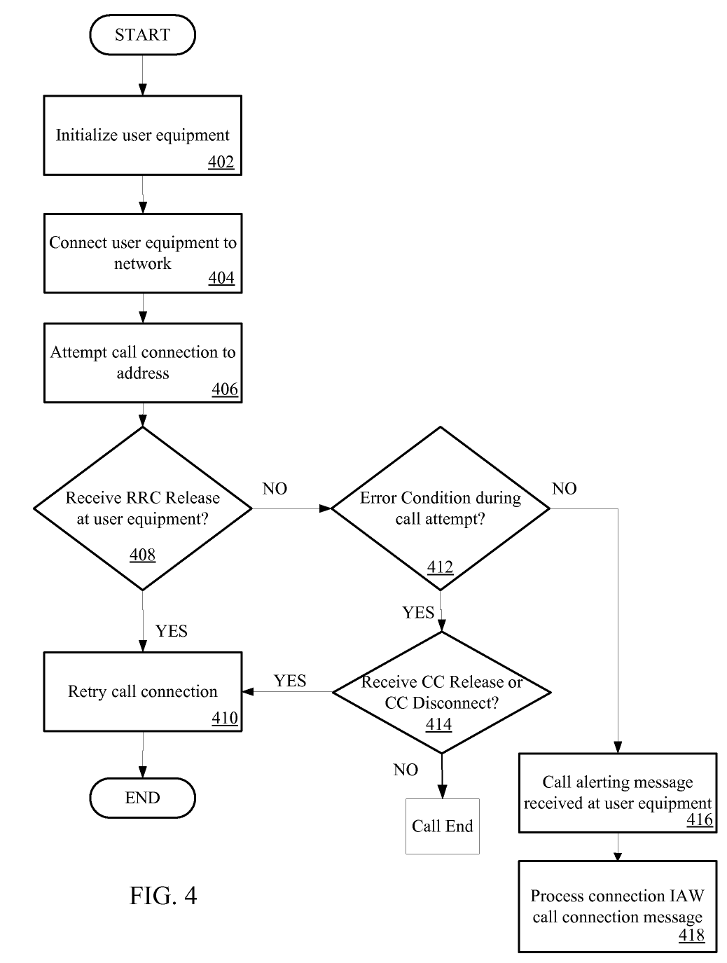

FIG. 4 illustrates examples acts taken to selectively retry a call connection in a 3GPP CDMA network. A UE 205 is initialized, at step 402. The UE 205 may power up, perform consistency and self-check steps, load programs or subroutines from a storage, and search for available networks. The UE 205 connects to a 3GPP network 215, at step 404. The UE 205 and the 3GPP network 215 may exchange initialization information, perform handshakes, or set up protocols and channels for communication. The UE 205 may attempt a call connection, at step 406. The UE 205 determines, at step 408, whether an RRC Release message has been received from the 3G network 215. If the UE 205 receives an RRC Release message, the UE 205 retries the call connection attempt, at step 410. In one embodiment, the CDMA call stack in the UE 205 only retries the call attempt once after a call failure setup.

If the UE 205 does not receive an RRC Release message, the UE 205 determines if an error condition has occurred during the call setup attempt, at step 412. The UE 205 may detect any received call connection messages, such as a CC Release or a CC Disconnect message, at step 414. If the UE 205 receives a call connection message, the UE 205 retries the call connection attempt, at step 410. If the UE 205 does not detect any error conditions during the call connection setup, the UE 205 may receive a call alerting message, at step 416. The UE 205 may then process any call connections or call connection messages according to procedures, such as the 3PP specification, at step 418.

A selective call retry system allows an improved caller perception by attempting to retry a call setup after receiving a call connection message. The caller does not need to be prompted after a call setup failure, because the selective call retry system processes call connection messages due to call setup failures, before a call alerting message is received by the caller's device.

In the methods shown in FIG. 4, the sequence diagrams may be encoded in a signal bearing medium, a computer readable medium such as a memory, programmed within a device such as one or more integrated circuits, or processed by a controller or a computer. If the methods are performed by software, the software may reside in a memory resident to or interfaced to the UE 205, a communication interface, or any other type of non-volatile or volatile memory interfaced or resident to the network 215 or UE 205. The memory may include an ordered listing of executable instructions for implementing logical functions. A logical function may be implemented through digital circuitry, through source code, through analog circuitry, or through an analog source such as through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may comprise any module that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium include: an electrical connection having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While the principles of the present disclosure have been described above in connection with specific apparatus, it is to be clearly understood that this description is made only by way of example and not as a limitation on the scope of the disclosure. It is therefore intended that the foregoing detailed description be regarded as illustrative rather than limiting, and that it be understood that it is the following claims, including all equivalents, that are intended to define the spirit and scope of the present disclosure.

1. A wireless communications device for a code division multiple access network, comprising selective call retry logic that attempts a call connection when a call setup failure is due to a 3GPP call connection message, which is received by the wireless communications device before receiving a 3GPP alerting message.

2. The wireless communications device of claim 1, wherein the selective call retry logic is configured to attempt a call connection only once after a call setup failure.

3. The wireless communications device of claim 1, wherein the 3GPP alerting message indicates that user alerting has been initiated at a called address.

4. The wireless communications device of claim 1, wherein the 3GPP alerting message comprises a call control (CC) alerting message.

5. The wireless communications device of claim 4, wherein the 3GPP call connection message comprises a radio resource control (RRC) release message.

6. The wireless communications device of claim 4, wherein the 3GPP call connection message comprises a CC disconnect message, the CC disconnect message received due to predetermined connection error types.

7. The wireless communications device of claim 4, wherein the 3GPP call connection message comprises a CC release message, the CC release message received due to predetermined connection error types.

8. A method for selectively attempting a call connection retry in a code division multiple access wireless communications device, the method comprising:
receiving a 3GPP connection message;
receiving, after receiving the 3GPP connection message, a 3GPP alerting message that indicates user alerting has been initiated at a called address; and
attempting a call connection retry.

9. The method of claim 8, wherein attempting the call connection retry comprises attempting the call connection retry only once.

10. A third generation (3G) code division multiple access (CDMA) network, comprising:
a 3G base station; and
a 3G wireless mobile communications device operatively connected to the CDMA network;
wherein the 3G base station is operable to transmit a 3G call connection message to the 3G wireless mobile communications device before the 3G wireless mobile communication device receives a 3G call alerting message, and the 3G wireless mobile communications device attempts a call connection when a call setup failure is due to the 3G call connection message.

11. The 3G CDMA network of claim 10, wherein the 3G wireless communications device attempts a call connection only once after the call setup failure.

12. The 3G CDMA network of claim 10, wherein the 3G alerting message indicates that user alerting has been initiated at a called address.

13. The 3G CDMA network e of claim 1, wherein the 3G alerting message comprises a call control (CC) alerting message.

14. The 3G CDMA network of claim 13, wherein the 3G call connection message comprises a radio resource control (RRC) release message.

15. The 3G CDMA network of claim 13, wherein the 3G call connection message comprises a CC disconnect message, the CC disconnect message received due to predetermined connection error types.

16. The 3G CDMA network of claim 13, wherein the 3G call connection message comprises a CC release message, the CC release message received due to predetermined connection error types.

17. A computer program product comprising:
a computer useable medium having computer readable code embodied in the medium, the computer readable code executable to:
receive a code division multiple access (CDMA) connection message in a CDMA wireless mobile communications device;
receive, after receiving the CDMA connection message, a CDMA alerting message that indicates user alerting has been initiated at a called address; and
attempt a call connection retry.

18. The computer program product of claim 17, wherein computer readable code executable to attempt a call connection retry is configured to attempt a call connection only once after a call setup failure.

19. The computer program product of claim 17, wherein the CDMA alerting message indicates that user alerting has been initiated at a called address.

20. The computer program product of claim 17, wherein the CDMA alerting message comprises a call control (CC) alerting message.

21. The computer program product of claim 20, wherein the CDMA call connection message comprises a radio resource control (RRC) release message.

22. The computer program product of claim 17, wherein the CDMA call connection message comprises a CC disconnect message, the CC disconnect message received due to predetermined connection error types.

23. The computer program product of claim 17, wherein the CDMA call connection message comprises a CC release message, the CC release message received due to predetermined connection error types.
